(19) United States
(12) Patent Application Publication
(10) Pub. No.: US 2006/0156925 A1
(43) Pub. Date: Jul. 20, 2006

(54) Electrostatic precipitator incorporated in another high-voltage device

(76) Inventor: John P. Libera, Fallbrook, CA (US)

Correspondence Address: Steven L. Nichols;Rader, Fishman, & Grauer PLLC, River Park Corporate Center One, Ste. 150, River Front Pkwy., South Jordan, UT, 84095, US

(21) Appl. No.: 11/040,346

(22) Filed: Jan. 20, 2005

(51) Int. Cl. B03C 3/00

(52) U.S. Cl. 96/15

(57) ABSTRACT

A combination includes (1) a host device having a high voltage generator, where the host device is configured to perform a function other than dust collection or electrostatic precipitation; and (2) an electrostatic precipitator configured to share the output of the high voltage generator of the host device. A method of providing an electrostatic precipitator includes integrating an electrostatic precipitator into a host device that includes a high voltage generator, where said host device is configured to perform a function other than electrostatic precipitation; and sharing an output of the high voltage generator between the electrostatic precipitator and the host device. In some examples, the host device is a television set.

### BACKGROUND

Electric fields have the natural property of attracting dust and particulate matter that may be in the ambient environment, particularly in the air. This property of electric fields has long been used in air filtering devices in such diverse environments as coal mines, rock quarries, cement mills, grain elevators, etc. These filters, oftentimes the size of a building, have been proven to effectively remove a high percentage of solid contamination from the ambient environment. Without such filters that use an electric field, it would have been impossible or prohibitively expensive to achieve the same air quality. These systems are sometimes referred to as electronic air filters or cleaners, but are more properly referred to as electrostatic precipitators.

More recently, electrostatic precipitators have been used on a smaller scale to collect dust and clean the air in residences, offices, businesses, etc. Conventional electrostatic precipitators require the use of a high voltage differential to create the electric field that is then used to remove pollutants from the air. Unfortunately, the circuitry required to produce and regulate these high voltages contributes significantly to the cost of an electrostatic precipitator. In fact, the high voltage generator may be the most expensive component of a conventional electrostatic precipitator.

### SUMMARY

A combination includes (1) a host device having a high voltage generator, where the host device is configured to perform a function other than dust collection or electrostatic precipitation; and (2) an electrostatic precipitator configured to share the output of the high voltage generator of the host device. A method of providing an electrostatic precipitator includes integrating an electrostatic precipitator into a host device that includes a high voltage generator, where said host device is configured to perform a function other than electrostatic precipitation; and sharing an output of the high voltage generator between the electrostatic precipitator and the host device. In some examples, the host device is a television set.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates a high voltage device that incorporates an electrostatic precipitator according to the principles described herein.

FIG. 2 shows a television set that incorporates an electrostatic precipitator according to the principles described herein.

FIG. 3 shows a block diagram of one example of an electrostatic precipitator utilizing the high voltage circuitry of a television according to the principles described herein.

FIG. 4 shows a block diagram of a second example of an electrostatic precipitator utilizing the high voltage circuitry of a television according to the principles described herein.

FIG. 5 is a flow chart illustrating an exemplary method of operating a television incorporating an electrostatic precipitator according to principles described herein.

FIG. 6 is a flow chart illustrating a second exemplary method of operating a television incorporating an electrostatic precipitator according to principles described herein.

Throughout the drawings, identical reference numbers designate similar, but not necessarily identical, elements.

### DETAILED DESCRIPTION

The present specification describes various systems and methods in which an electrostatic precipitator is incorporated into some other device that already includes and uses a high voltage generator, for example, a television set. A major component of the cost of an electrostatic precipitator is the high voltage generator. By incorporating the electrostatic precipitator into a host device, such as a television set, the precipitator can make use of the high voltage power generator of the host device at a significant cost savings.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one example” or “an example” means that a particular feature, structure, or characteristic described in connection with the example is included in at least one example. The various appearances of the phrase “in one example” in the specification are not necessarily all referring to the same example.

As used herein, and in the appended claims, the term “electrostatic precipitator” or “ESP” will be broadly understood to refer to any device that uses an electrostatic field to remove dust and other contaminants from the air. Consequently, as used herein, the term electrostatic precipitator may include a variety of electronic air cleaners, electronic air filters, etc. Also as used herein and in the appended claims, the term “dust” will be used to refer collectively to any and all dust, dirt, allergens, contaminants, particulate matter, etc. collected by an electrostatic precipitator. The term “host device” will be used herein and in the appended claims to refer to any device that requires a high voltage generator for some purpose other than air filtration or cleaning and in which an electrostatic precipitator might be incorporated.

As noted above, devices that utilize a high voltage differential are natural collectors of particles such as dust. As will be described in more detail below, the electric field generated by the circuitry in these devices serves to polarize and accelerate particles in the ambient environment. Consequently, normal operation of these high voltage devices can result in the collection of copious amounts of dust which can, in turn, impede cooling and induce thermal stress that may eventually lead to failure of the high voltage device. This effect, by which particles such as dust collect on high voltage devices, has conventionally been viewed as undesirable. Consequently, baffles, non-powered air filters or other measures are often used to prevent dust from collecting on, entering or otherwise affecting a high voltage device.

Electrostatic precipitators operate on the principle that mechanical forces can result from electric fields. Coulomb's law states that a charged body in an electric field experiences a force proportional to the strength of the electric field and the charge of the body. Specifically, F=q*E, where ‘F’ represents the force on the mass, ‘q’ represents the charge of the body, and ‘E’ represents the strength of the electric field in which the charged body resides. Newtonian physics holds that the force on a body is proportional to its mass and its acceleration. Specifically, F=m*a, where ‘F’ represents the force on the body, ‘m’ represents the mass of the body, and ‘a’ represents the acceleration of the body. By equating the notion of force from Coulomb's law with the definition of force from classical mechanics, it can be seen that, m*a=q*E, and that, a=(q*E)/m.

In the presence of intense electrical fields, small particles, such as dust, are easily polarized. In this context, polarization is the process by which an electrically neutral body acquires a net charge in different regions and thus behaves as a charged body. As predicted by the above equation, a=(q*E)/m, polarized particles with small mass, in the presence of strong electric fields, can experience significant acceleration. The smaller the particle and the more intense the electric field, the greater the acceleration. Consequently, the particles move to, and are collected by, structures generating or that are located within the electric field.

As noted above, the most significant expense associated with an electrostatic precipitator is usually the high voltage generator. If the electrostatic precipitator can be incorporated into and share a high voltage generator with a device that already needs a high voltage generator for some purpose other than dust collection, the benefits of the electrostatic precipitator can be realized at significantly less expense than would be required if providing a separate electrostatic precipitator unit with its own high voltage generator.

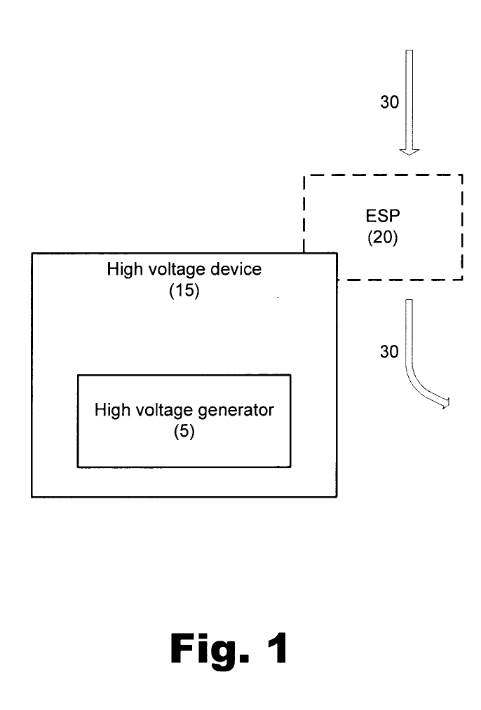

Consequently, FIG. 1 illustrates a high voltage device (15) that incorporates an electrostatic precipitator (20). As used herein and in the appended claims, a high voltage device will be understood as a device that incorporates a high voltage generator for some purpose other than dust collection. Also as used herein and in the appended claims, “high voltage” will refer to a relatively high voltage used in the operation of such devices as television sets, computer monitors, laser printers/copiers, microwave ovens, etc. Such high voltages may range, for example, from 5-40 kV or higher.

As shown in FIG. 1, a high voltage device (15) includes a high voltage generator (5). This generator (5) produces the high voltages needed for the device (15) to perform some operation other than dust collection. However, the voltage differential produced by the high voltage generator (5) is also shared with and used by an electrostatic precipitator (20) incorporated in the device (15) according to principles described herein. In this way, a functioning electrostatic precipitator can be provided at much less expense than would be required to provide a separate electrostatic precipitator unit with its own high voltage generator.

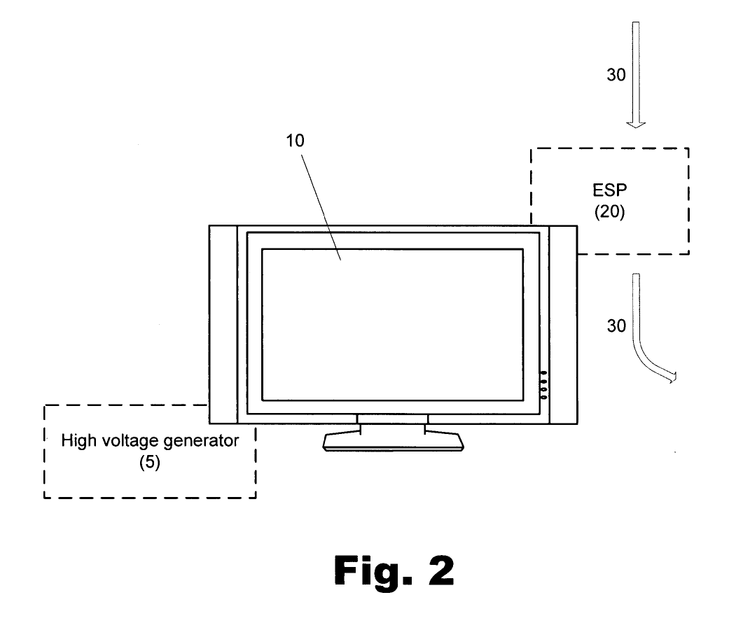

A specific example of a high voltage device (15) that could profitably include an electrostatic precipitator is a television set. FIG. 2 illustrates a television set (10) that incorporates an electrostatic precipitator (20) according to principles described herein. As shown in FIG. 2, the electrostatic precipitator (20) is part of the television set (10). As will be described in more detail below, the high voltage generator (5) of the television set (10) is also used to provide a high voltage differential in the electrostatic precipitator (20).

Ambient air (30) is allowed to circulate to, around or through the electrostatic precipitator (20) as shown in FIG. 1. A fan or similar device may be used, in some examples, to force air through the electrostatic precipitator (20). However, in the illustrated example, no such device is used and the air (30) naturally circulates through or by the electrostatic precipitator (20). As described above, dust and other contaminants are collected from the air (30) and ambient environment by the electric field of the electrostatic precipitator (20). As a result, air leaving the electrostatic precipitator (20) is cleaner than air entering the electrostatic precipitator (20). Over time, the electrostatic precipitator (20) produces generally cleaner air in the room or vicinity where the television (10)/electrostatic precipitator (20) is located.

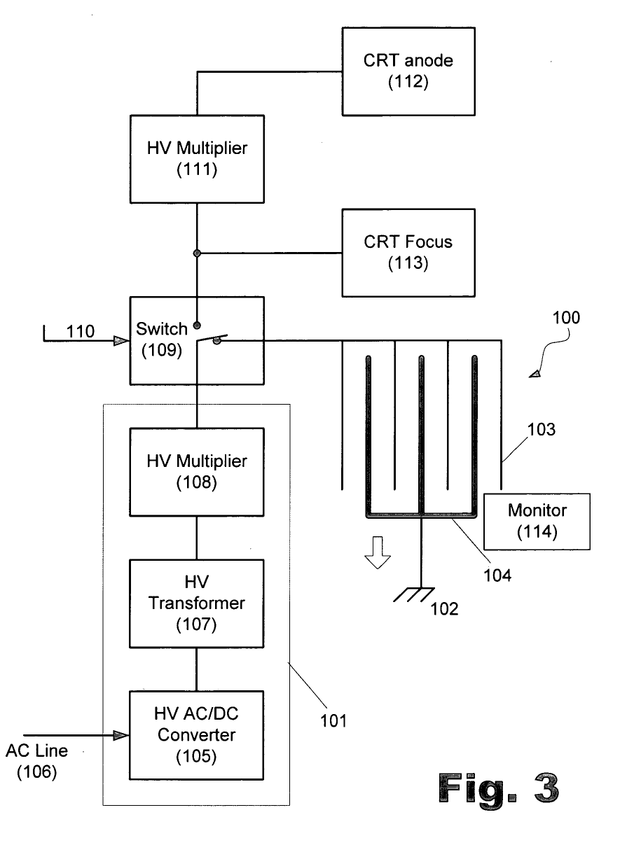

FIG. 3 shows a block diagram of one example of an electrostatic precipitator utilizing the high voltage circuitry of a television set according to the principles described herein. As shown in FIG. 3, the electrostatic precipitator (100) is constituted by a high voltage generator (101), a discharging electrode (103), and a collecting electrode (104).

In some examples, the discharging electrode (103) is a series of long thin wires. The collecting electrode (104) is made of some durable material such as stainless steel and has the form of elongated plates or strips. The discharging electrode (103) is electrically connected to the high voltage generator (101). The collecting electrode (104) is electrically connected to an electrical ground (102). This ground (102) may be common to the high voltage generator (101).

When a high voltage differential exists between the discharge electrode (103) and the collecting electrode (104), particles such as dust, are easily polarized and accelerated towards the collecting electrode (104). Acceleration of the particles is directly proportional to the strength of the electric field produced by the electrodes (103, 104). Because electric field strength increases with voltage and decreases with distance between electrodes, strong electric fields result from electrodes which are close together and that have a high voltage differential between them.

The shape of the discharging electrode (103) can significantly contribute to the performance of the electrostatic precipitator (100). Discharging electrodes that have a small curve radius, are sharp-pointed, or comprise pointed shapes further enhance the ability of the electrostatic precipitator (100) to polarize and accelerate particles towards the collecting electrode (104).

The illustrated television set (FIG. 2) includes a Cathode Ray Tube (CRT), a portion of which is the screen of the television on which images are displayed. While operating, a typical CRT requires the application of high voltages that range from 6 kV to 40 kV. By using the high voltage circuitry of the television to also power an electrostatic precipitator, the problem of particle accumulation on the television is mitigated and the air filtering effect of the electrostatic precipitator is achieved at a smaller cost than would be possible if providing a discrete high voltage generator for the electrostatic precipitator.

Consequently, as shown in FIGS. 2 and 3, an electrostatic precipitator (100) is incorporated into a television set (10, FIG. 2). As shown in FIG. 3, the high voltage generator (101) includes a high voltage alternating current/direct current (AC/DC) converter (105). This converter (105) is connected to an alternating current (AC) power line (106), such as a typical wall outlet. The converter (105) uses the AC input (106) and outputs DC pulses to a high voltage transformer (107). The transformer (107) increases the voltage of the pulses, which are then input to a high voltage multiplier (108). The high voltage multiplier (108) further increases the voltage of the pulse to produce the DC output of the high voltage generator (101).

As shown in FIG. 3, a switch (109) may be used to selectively provide the high voltage signal from the generator (101) to either the discharge electrode (103) or to the circuitry of the television set (10, FIG. 2). A control signal (110) controls the switch (109).

When the high voltage signal is being applied to the circuitry of the television set, the switch (109) connects the high voltage generator (101) with the cathode ray tube (CRT) focus (113) and anode (112) of the television. The CRT focus (113) receives the signal from the high voltage generator (101) by way of the switch (109). The CRT anode (112) receives the voltage signal after it has been converted to a still higher voltage by an additional high voltage multiplier (111) connected between the switch (109) and the anode (112).

As will be described further below, the control signal (110) varies in different examples described herein. In one example, the control signal (110) connects the high voltage from the generator (101) to the electrostatic precipitator (100) when the television set (112, 113) is turned off and is not operating. In another example, the control signal (110) operates the switch (109) to provide high voltage pulses to the electrostatic precipitator (100) during vertical blanking intervals that occur during the operation of the television set, represented in FIG. 3 by the CRT anode (112) and focus circuit (113).

During normal operation, the collecting electrode (104) collects significant amounts of dust. This compromises the ability of the electrostatic precipitator (100) to remove further dust and particles from the air and increases the likelihood of electrical discharge. This problem can be solved by regularly cleaning the collecting electrode (104). For this reason, the collecting electrode (104) is made to be removed from the electrostatic precipitator (100) as shown by the arrow in FIG. 3.

The cleaning process involves removing the particle buildup from the collecting electrode (104). This can be done with a damp cloth or by putting the collecting electrode (104) in the dishwasher. It is likely, however, that consumers will forget to perform this act. To ameliorate this, a monitor (114) can be used to monitor the build up of particles on the collecting electrode (104) and relate this information to the user. In the illustrated example, when the monitor (114) determines that the electrode (104) needs to be cleaned, the monitor (114) uses the television to send an audible, visible, or otherwise interpretable message to the user to indicate that the electrode (104) needs to be cleaned.

For any number of reasons, the consumer may not want to clean the electrode (104). Consequently, the collecting electrode (104) can be formed in a disposable unit that can be replaced as needed. In this manner, the advantages of having clean electrodes can be achieved without cleaning the electrodes. The collecting electrode (104) can be made of any electrically conductive material. Some examples include aluminum foil reinforced with polypropylene sheet material; carbonized paper on corrugated cardboard; and conductive paint applied to fabric, plastic, cardboard or other supporting disposable material. A suitable disposable collecting electrode (104) can be made from these and other materials.

As with the permanent electrodes, the monitor (114) can still be used to monitor the condition of the disposable electrode and indicate to the user that the disposable electrode unit needs to be replaced. The electrostatic precipitator can also be designed so that either a disposable or permanent collecting electrode can be used. This gives consumers the option to choose whether to periodically clean the collecting electrode or simply replace a disposable electrode unit.

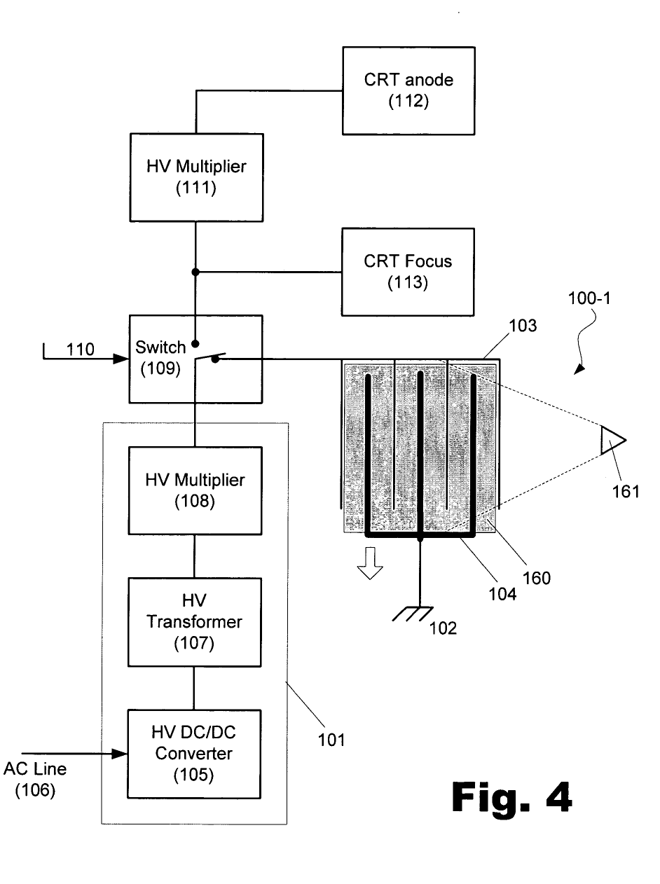

FIG. 4 shows a block diagram of a second example of an electrostatic precipitator utilizing the high voltage circuitry of a television according to the principles described herein. The example illustrated in FIG. 4 is similar to that of FIG. 3 and a redundant explanation of components already described will be omitted.

As shown in FIG. 4, the assembly of the discharge electrode (103) and the collecting electrode (104) can include reactive carbon or charcoal (160). This would neutralize any ozone created by the electrostatic precipitator and would also neutralize any other gaseous contaminants in the air. In this configuration, the electrostatic precipitator (100) would remove both dust, and gaseous contaminants or odors from the air.

Additionally, microorganisms such as bacteria and mold will be collected by the electrostatic precipitator (100). These microorganisms can be killed by exposure to an ultraviolet light (161). An electrostatic precipitator (100), equipped with an ultraviolet light source (161), is capable of killing airborne microorganisms as well as removing dust from the air.

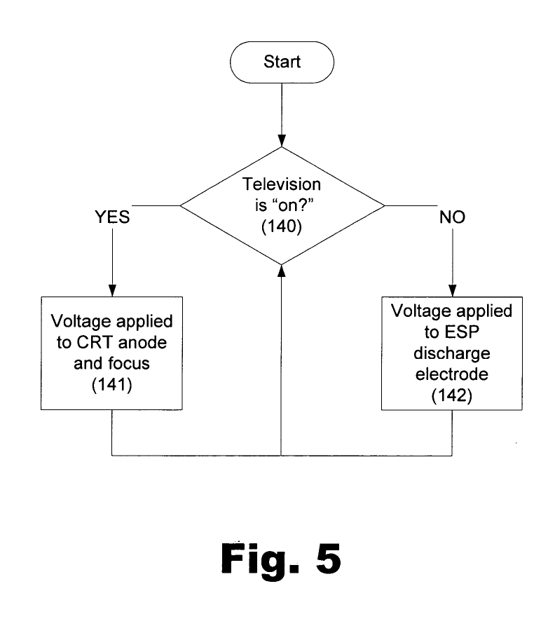

FIG. 5 is a flow chart illustrating an exemplary method of operating a television incorporating an electrostatic precipitator according to principles described herein. As shown in FIG. 5, the electrostatic precipitator described herein can be powered and receive a high voltage potential during periods of time when the television set, in which the electrostatic precipitator is incorporated, is turned off.

As shown in FIG. 5, if the television is turned on (determination 140), then the voltage potential from the high voltage generator is supplied to the circuitry of the television, e.g., the CRT anode and focus (step 141). However, if the television set is turned off (determination 140), then the voltage potential from the high voltage generator is supplied to the electrostatic precipitator (step 142). Assuming the television set is off a majority of the time, this will allow the electrostatic precipitator to operate a majority of the time and suitably clean the air of the room or vicinity where the television is located.

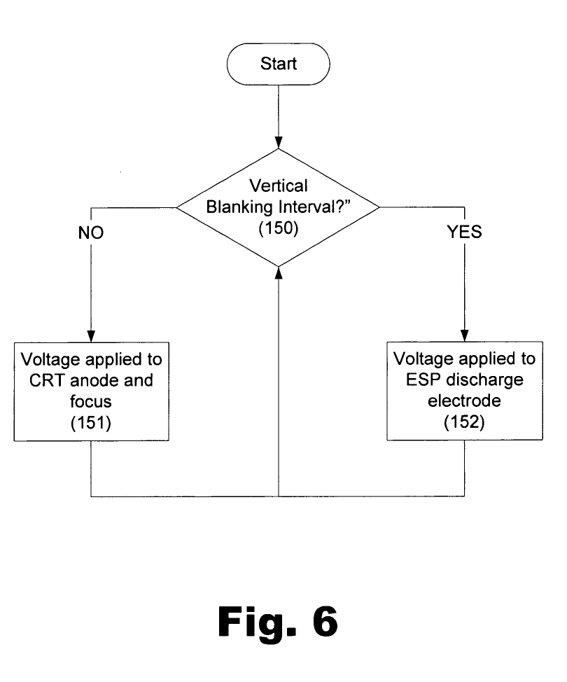

FIG. 6 is a flow chart illustrating a second exemplary method of operating a television set incorporating an electrostatic precipitator according to principles described herein. In the method of FIG. 6, the electrostatic precipitator is powered with pulses delivered during the vertical blanking intervals that occur when the television set is in operation.

As shown in FIG. 6, if a vertical blanking interval is occurring (determination 150), the control signal (110, FIG. 3) connects the voltage generator (101, FIG. 3) to the electrostatic precipitator (step 152). At all other times during operation of the television, the control signal (110, FIG. 3) connects the voltage generator (101, FIG. 3) with the television circuitry for generating an image.

During normal operation, electrostatic precipitators have the tendency to experience minute electrical discharge. This electrical discharge can arise from a number of conditions including extremely polluted electrodes, a high concentration of dust in the air, and certain combinations of atmospheric conditions such as humidity and temperature. Electrical discharge does not pose any threat to safety because of the low current nature of the power source and the protection circuits present in electrostatic precipitator circuitry. However, these discharges would likely interrupt the normal operation of the host apparatus which supplies the high voltage to the electrostatic precipitator, for instance degrade the picture quality of the television set. One solution to this problem is to only operate the electrostatic precipitator while the apparatus supplying the high voltage to the electrostatic precipitator is not functioning, as in FIG. 5.

Another solution to the problem of electrical discharge degrading the performance of the high voltage supplying device can be achieved by synchronizing the operation of the electrostatic precipitator with intervals in which the supplying device does not utilize its high voltage resources. In this configuration, the electrostatic precipitator is energized during these frequent, short periods of time in which the supplying device doesn't use its high voltage supply, as in FIG. 6. This pulsed operation of the electrostatic precipitator provides several potential benefits. These include a reduction in power consumption, an increase in particle precipitation efficiency, and a decrease in the likelihood of electrical discharge.

In the example illustrated in FIG. 6, the operation of the electrostatic precipitator is synchronized with the vertical blanking intervals of the television. When the pulsed operation is synchronized with the video frame frequency, the sporadic electrical discharges occur during blanked periods of video transmission that are not observable on the CRT screen. The likelihood of the occurrence of electrical discharge can be reduced as well by employing a device that detects the discharges and reacts by reducing the voltage applied to the electrodes, skips pulses of operation, or disables the electrostatic precipitator.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A combination comprising:
a host device comprising a high voltage generator configured to perform a function other than dust collection; and
an electrostatic precipitator configured to share an output of said high voltage generator with said host device.

2. The combination of claim 1, wherein said electrostatic precipitator comprises a discharge electrode and a replaceable collecting electrode.

3. The combination of claim 2, further comprising a monitor for monitoring dust accumulation on said collecting electrode.

4. The combination of claim 3, wherein said monitor is configured to signal a user when said collecting electrode needs to be cleaned.

5. The combination of claim 3, wherein said monitor is configured to signal a user when said collecting electrode needs to be replaced.

6. The combination of claim 2, wherein said collecting electrode is disposable.

7. The combination of claim 6, wherein said collecting electrode comprises aluminum foil reinforced with polypropylene sheet material.

8. The combination of claim 6, wherein said collecting electrode comprises carbonized paper on corrugated cardboard.

9. The combination of claim 6, wherein said collecting electrode comprises conductive paint.

10. The combination of claim 2, wherein said collecting electrode comprises electrodes with a curved shape.

11. The combination of claim 2, wherein said collecting electrode comprises electrodes with a pointed shape.

12. The combination of claim 1, wherein said electrostatic precipitator further comprises reactive carbon or charcoal.

13. The combination of claim 1, wherein said electrostatic precipitator further comprises an ultraviolet light source.

14. The combination of claim 1, wherein said host device comprises a television set and said electrostatic precipitator is integrated into said television set.

15. The combination of claim 14, further comprising a control switch configured to provide said output of said high voltage generator to said electrostatic precipitator when said television set is not operating to display programming.

16. The combination of claim 14, further comprising a control switch configured to provide said output of said high voltage generator to said electrostatic precipitator during vertical blanking intervals during operation of said television set.

17. A combination comprising:
a television comprising a high voltage generator; and
an electrostatic precipitator configured to share an output of said high voltage generator with said television.

18. The combination of claim 17, wherein said electrostatic precipitator comprises a discharge electrode and a replaceable collecting electrode and said combination further comprises a monitor for monitoring dust accumulation on said collecting electrode, wherein said monitor is configured to alert a user when said collecting electrode has accumulated a predetermined amount of dust.

19. The combination of claim 18, wherein said monitor is configured to output a visual alert to said user using said television set when said collecting electrode has accumulated a predetermined amount of dust.

20. The combination of claim 18, wherein said monitor is configured to output an audio alert to said user using said television set when said collecting electrode has accumulated a predetermined amount of dust.

21. The combination of claim 18, wherein said monitor is configured to signal a user when said collecting electrode needs to be replaced.

22. The combination of claim 17, wherein said electrostatic precipitator comprises a disposable collecting electrode.

23. The combination of claim 22, wherein said collecting electrode comprises aluminum foil reinforced with polypropylene sheet material.

24. The combination of claim 22, wherein said collecting electrode comprises carbonized paper on corrugated cardboard.

25. The combination of claim 22, wherein said collecting electrode comprises conductive paint.

26. The combination of claim 22, wherein said collecting electrode comprises electrodes with a curved shape.

27. The combination of claim 22, wherein said collecting electrode comprises electrodes with a pointed shape.

28. The combination of claim 17, wherein said electrostatic precipitator further comprises reactive carbon or charcoal.

29. The combination of claim 17, wherein said electrostatic precipitator further comprises an ultraviolet light source.

30. The combination of claim 17, further comprising a control switch configured to provide said output of said high voltage generator to said electrostatic precipitator when said television is not operating to display programming.

31. The combination of claim 17, further comprising a control switch configured to provide said output of said high voltage generator to said electrostatic precipitator during vertical blanking intervals during operation of said television.

32. A method of providing an electrostatic precipitator comprising:
integrating said electrostatic precipitator into a host device comprising a high voltage generator, wherein said host device is configured to perform a function other than electrostatic precipitation; and
sharing an output of said high voltage generator between said electrostatic precipitator and said host device.

33. The method of claim 32, further comprising providing a switch for selectively connecting said host device and said electrostatic precipitator to said high voltage generator.

34. The method of claim 32, further comprising forming said electrostatic precipitator of a discharge electrode and a replaceable collecting electrode.

35. The method of claim 34, further comprising making said collecting electrode using aluminum foil reinforced with polypropylene sheet material.

36. The method of claim 34, further comprising making said collecting electrode using carbonized paper on corrugated cardboard.

37. The method of claim 34, further comprising making said collecting electrode using conductive paint.

38. The method of claim 34, further comprising providing a monitor for monitoring dust accumulation on said collecting electrode.

39. The method of claim 38, further comprising issuing an alert with said monitor when said collecting electrode requires cleaning or replacement.

40. The method of claim 34, further comprising forming said collecting electrode with a curved shape.

41. The method of claim 34, further comprising forming said collecting electrode with a pointed shape.

42. The method of claim 32, further comprising providing reactive carbon or charcoal with said electrostatic precipitator.

43. The method of claim 32, further comprising providing an ultraviolet light source with said electrostatic precipitator.

44. The method of claim 32, wherein said host device comprises a television set and said method comprises integrating said electrostatic precipitator into said television set.

45. A method of operating a combination of a television and an electrostatic precipitator wherein said television and said electrostatic precipitator share a common high voltage generator, said method comprising selectively providing an output of said high voltage generator to said electrostatic precipitator when said television set is not operating to display programming.

46. A method of operating a combination of a television and an electrostatic precipitator wherein said television and said electrostatic precipitator share a common high voltage generator, said method comprising selectively providing an output of said high voltage generator to said electrostatic precipitator during vertical blanking intervals during operation of said television set.

47. A device comprising:
means for generating a high voltage differential;
means for selectively using said high voltage differential for electrostatic precipitation; and
means for selectively using said high voltage differential for a function other than electrostatic precipitation.
